(19) United States
(12) Patent Application Publication
(10) Pub. No.: US 2003/0016689 A1
(43) Pub. Date: Jan. 23, 2003

(54) Switch fabric with dual port memory emulation scheme

(76) Inventor: Werner Van Hoof, Kanata (CA)

Correspondence Address: CHRISTIE, PARKER & HALE, LLP, P.O. BOX 7068, PASADENA, CA, 91109-7068, US

(21) Appl. No.: 10/180,279

(22) Filed: Jun. 26, 2002

Related U.S. Application Data
(60) Provisional application No. 60/306,174, filed on Jul. 17, 2001.

(51) Int. Cl. H04L 12/54

(52) U.S. Cl. 370/428; 370/412

(57) ABSTRACT

A switch fabric supporting a dual port memory emulation scheme using two single port memories. If a read action for retrieving a stored packet is scheduled for one single port memory, the write action for storing a packet is performed on the other single port memory. Each packet is stored in the memory a data word at a time, and referenced by a linked list of previous pointers that refer to a previous data word stored in the memory, resulting in a single write-in step of the pointer information for each data word. In retrieving the stored packet, each data word is retrieved in a backward manner by following the linked list of previous pointers where the end of the packet is retrieved first, and the beginning of the packet is retrieved last.

### CROSS-REFERENCE TO RELATED APPLICATION(S)

This application claims the benefit of U.S. provisional application No. 60/306,174, filed on Jul. 17, 2001, the content of which is incorporated herein by reference.

### REGISTER OF THE INVENTION

This invention relates generally to packet switching systems, and more particularly, to a single port switch fabric memory emulating a dual port switch fabric memory.

### BACKGROUND OF THE INVENTION

A switch fabric in a data communications switch facilitates the transport of data packets received from an ingress port to an egress port for forwarding the packet to a destination. The switch fabric may be implemented as a crossbar switch, cell switch, or shared memory packet switch. One advantage of the shared memory packet switch when compared to other types of switch fabrics is its robustness under high traffic loads. Shared packet memory switches generally provide for lower packet loss and lower latency than other types of switch fabrics.

The memory in a shared packet memory switch is generally implemented as a single port dynamic random access memory (DRAM). FIG. 1 is an exemplary block diagram of a typical single port memory 60 that may be found in the art. The memory includes a single address bus 62, control bus 64, and data bus 66. The single address, control, and data busses are used to receive and store packets in the memory in response to write commands, as well as retrieve and transmit stored packets from the memory in response to read commands.

One deficiency with the single port memory, however, is that it only supports one memory access at a time, whether it be a read access or a write access. Thus, neither multiple read accesses nor multiple write access may be performed concurrently, limiting the bandwidth to and from the memory and creating a bottleneck that limits system performance. In addition, read-write collisions may occur when read actions are attempted concurrently with the write actions, often causing stalls in the reading or writing of packets.

A common approach in trying to avoid read-write collisions is to replace the single port RAM with a dual port RAM. FIG. 2 is an exemplary block diagram of a typical dual port memory 80 that may be found in the art. The dual port memory 80 includes two address busses 82a, 82b, control busses 84a, 84b, and data busses 86a, 86b. The dual port memory allows the concurrent retrieval and storage of packets from and to the same memory 80 via the separate busses without the risk of read-write collisions, allowing data throughput to and from the memory to be doubled without changing the access timing.

Although dual port memories avoid read-write collisions, they are often not available with the memory capacity needed for switch fabrics, and are also not available as DRAMs, which are commonly used for such switch fabrics. In addition, dual port memories are generally not as area efficient as single port memories.

Accordingly, there is a need for a switch fabric that maximizes data throughput using single port memories without the risk of read-write collisions.

### SUMMARY OF THE INVENTION

The present invention is directed to a switch fabric with a dual port memory emulation scheme using single port memories. According to one embodiment, the switch fabric includes an input and a memory coupled to the input including a first memory unit and a second memory unit, characterized in that either the first memory unit or the second memory unit is selected for performing a first memory access operation on at least a portion of a first packet, the selection being based on the memory unit selected for performing a second memory access operation on at least a portion of a second packet.

According to another embodiment, the invention is directed to a switch fabric with a dual port memory emulation scheme where the switch fabric includes a first single port memory including a single first input port, a single first address port, and a single first output port, and a second single port memory including a single second input port, a single second address port, and a single second output port. According to this embodiment, if a second memory access operation is to be performed on the first single port memory, a first memory access operation is performed on the second single port memory. Furthermore, if the second memory access operation is to be performed on the second single port memory, the first memory access operation is performed on the first single port memory.

According to one embodiment, the first memory access operation is a write operation and the second memory access operation is a read operation.

According to another embodiment, the first and second memory access operations are performed concurrently in a non-blocking manner.

It should be appreciated, therefore, that the present invention allows emulation of a dual port memory using single port memories. The read and write actions may be performed within a same operational cycle in a non-blocking manner because at any given cycle, the read and write actions occur in different single port memories. This present invention, therefore allows data throughout to be maximized without the risk of read-write collisions.

These and other features, aspects and advantages of the present invention will be more fully understood when considered with respect to the following detailed description, appended claims, and accompanying drawings. Of course, the actual scope of the invention is defined by the appended claims.

### BRIEF DESCRIPTION OF THE DRAWINGS

FIG. 1 is an exemplary block diagram of a typical single port memory that may be found in the art;

FIG. 2 is an exemplary block diagram of a typical dual port memory that may be found in the art;

FIG. 3 is a schematic block diagram of a packet switching system with a dual port memory emulation scheme according to one embodiment of the invention;

FIG. 4 is a schematic block diagram of an exemplary ingress control unit according to one embodiment of the invention;

FIG. 5 is a schematic block diagram of an exemplary packet buffer unit according to one embodiment of the invention;

FIG. 6 is a schematic block diagram of an exemplary egress control unit according to one embodiment of the invention;

FIG. 7 is a more detailed block diagram of a portion of the packet buffer unit of FIG. 5 according to one embodiment of the invention;

FIG. 8 is a schematic layout diagram of a data memory in the packet buffer unit of FIG. 5 that is divided into the upper data memory and the lower data memory for emulating a dual port memory according to one embodiment of the invention;

FIG. 9 is a flow diagram of a process exercised by the packet buffer unit of FIG. 5 in storing packets according to a dual port memory emulation scheme; and

FIG. 10 is a flow diagram of a process exercised by the packet buffer unit of FIG. 5 in retrieving packets according to a dual port memory emulation scheme.

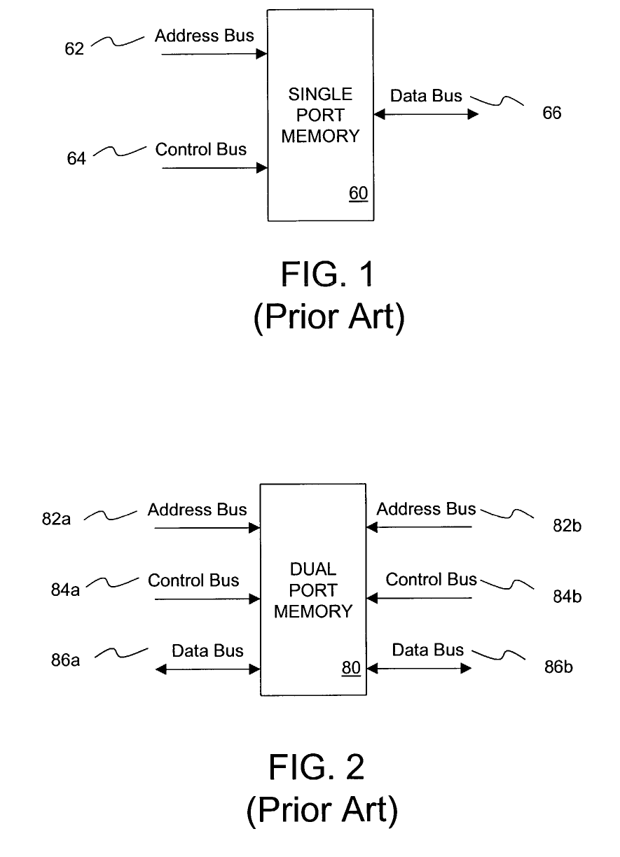

### DETAILED DESCRIPTION

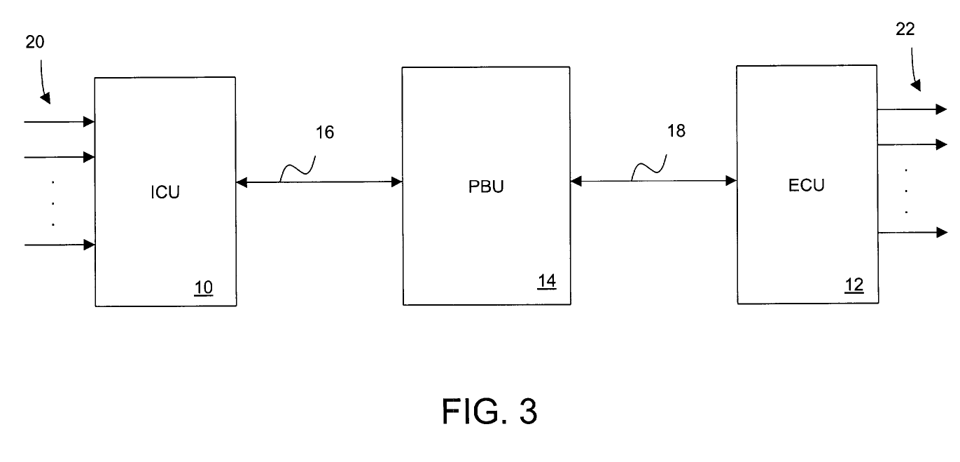

FIG. 3 is a schematic block diagram of a packet switching system with a dual port memory emulation scheme according to one embodiment of the invention. The system includes an ingress control unit (ICU) 10 and an egress control unit (ECU) 12 coupled to a switch fabric that is made up of a packet buffer unit (PBU) 14 that stores and forwards packets received from the ICU 10. The ICU 10 may have one or more associated input ports 20 and the ECU 12 may have one or more associated output ports 22. At any given time, all or a subset of the input ports 20 receive data packets which are destined for all or a subset of the output ports 22. The packets may include, but are not limited to Ethernet frames, ATM cells, TCP/IP and/or UDP/IP packets, and may also include other Layer 2 (Data link/MAC Layer), Layer 3 (Network layer), or Layer 4 (Transport Layer) data units.

Upon receipt of a packet by the ICU 10, the ICU forwards the packet to a PBU 14 for storing. The PBU 14 stores the packet in memory and transmits a notification to the ECU that may be interested in receiving the packet. The PBU 14 maintains the packet in memory until it is requested by the ECU. The ECU transmits a request to the PBU 14 to retrieve the packet when the ECU determines, based on its scheduling algorithm, that it is time to forward the packet. The PBU retrieves the packet in response to the request and transmits it to the ECU for forwarding via the one or more egress ports 22.

Although the embodiment illustrated in FIG. 3 depicts a single ICU and ECU coupled to a single PBU, a person skilled in the art should recognize that the packet switching system may include multiple ICUs and ECUs coupled to multiple PBUs via high speed serial links so that each ICU and ECU may communicate with each PBU, as is described in U.S. Patent Application entitled “Distributed Shared Memory Packet Switch,” (attorney docket number 47900/JEC/X2), filed on May 15, 2002, and assigned to the Assignee of the present case, the content of which is incorporated herein by reference.

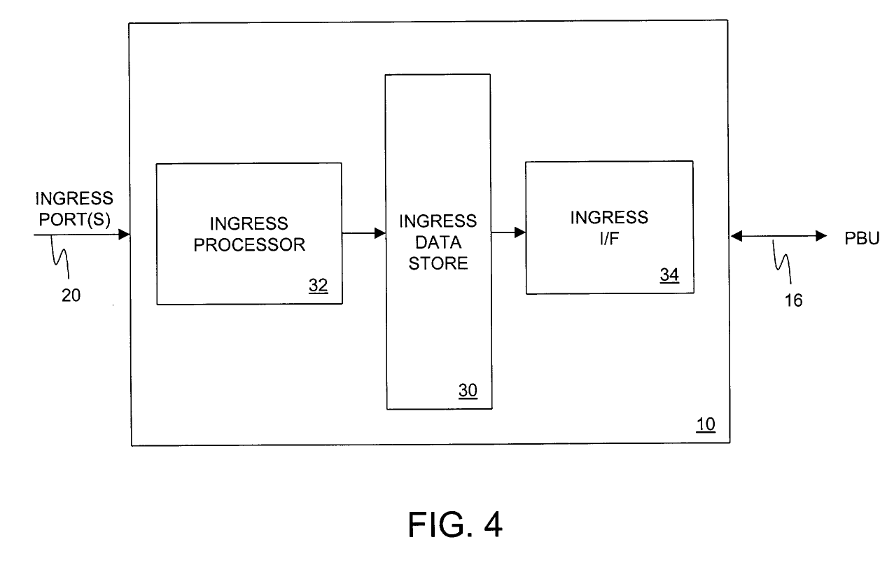

FIG. 4 is a schematic block diagram of an exemplary ICU 10 according to one embodiment of the invention. The ICU in the illustrated embodiment includes an ingress processor 32 which is coupled to an ingress data store 30 which is in turn coupled to an ingress interface 34. The ingress packet processor 32 receives inbound packets and performs policing, accounting, forwarding, and any other packet processing task for the packets as is conventional in the art.

The ingress data store 30 may be a first-in-first-out (FIFO) buffer for receiving and temporarily storing the inbound data packets. The ingress data store 30 may be desirable if the data rate of one or more of the ingress ports 20 is lower or higher than the data rate of the link 16 to the PBU 14. An embodiment may exist, however, where the ICU 10 does not include an ingress data store 30.

The ingress interface 34 forwards the inbound data packets to the PBU via link 16. In an embodiment where multiple PBUs 14 make up the switch fabric, a particular PBU may be selected based on a pseudo random algorithm that is adjusted by weight information associated with each PBU, for allowing the workload to be balanced among the various PBUs.

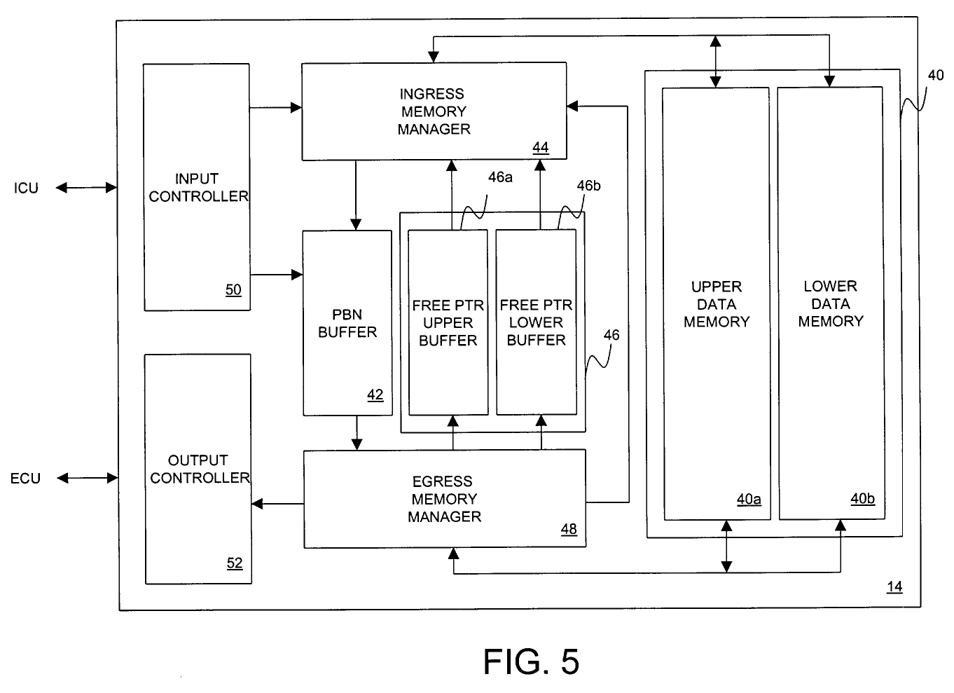

FIG. 5 is a schematic block diagram of an exemplary PBU 14 according to one embodiment of the invention. The PBU in the illustrated embodiment includes a shared packet data memory 40 for storing packets received from the ICU 10. Different portions of a particular packet are stored in the data memory in different memory locations that are accessed via a linked list of pointers.

According to one embodiment of the invention, the memory is divided into an upper data memory 40a and a lower data memory 40b. The upper data memory 40a is implemented as a first single port memory and the lower data memory 40b is implemented as a second single port memory. Each single port memory may be, for example, a single port DRAM, of an equal size. Alternatively, each single port memory may be of a different size.

The PBU 14 further includes a PBN buffer 42 which may be implemented as a dynamic random access memory (DRAM) or a static RAM (SRAM). Each entry in the PBN buffer 42 includes an address, referred to as a PBN address, which is a pointer to the data memory 40 where at least a portion of the packet is stored. According to one embodiment of the invention, the PBN address is a pointer to a memory location storing an end portion of the packet.

The PBN buffer 42 is coupled to a storage unit referred to as an ingress memory manager 44 that maintains track of the packets that are streamed from the ICU 10 to the data memory 40. The ingress memory manager 44 retrieves pointers to free memory locations from a free pointer buffer 46. The free pointer buffer 46 includes an upper buffer portion 46a and a lower buffer portion 46b. The upper buffer portion 46a stores pointers to available memory locations in the upper data memory 40a, and the lower buffer portion 46b stores pointers to available memory locations in the lower data memory 40b.

The ingress memory manager 44 stores all or portions of a packet in one or more free memory locations retrieved from the free pointer buffer 46. The ingress memory manager 44 maintains track of a previous pointer used to store a previous portion of the packet, and also stores the previous pointer in the free memory location with the packet data. This causes different portions of the packet to linked via a backward pointing mechanism where a current portion of the packet refers to a previous portion of the packet.

When an entire packet is written into the data memory 40, the ingress memory manager 44 adds an entry to the PBN buffer 42 for the newly stored packet. According to one embodiment, the entry includes a pointer to an end portion of the packet.

The PBU 14 also includes a processing unit referred to as an egress memory manager 48 that maintains track of packets that are streamed out of the data memory 40 to the ECU 12. The egress memory manager 48 transmits read commands to the data memory 40 to retrieve data from a particular memory location. The egress memory manager further detects packets that no longer need to be maintained in the memory 40 and frees their associated memory locations.

In addition to the above, the PBU 14 includes an input controller 50 and an output controller 52. The input controller 50 receives different types of messages from the ICU 10 and ECU 12, processes and separates the different types of messages for forwarding to the appropriate components within the PBU.

For example, the input controller 50 receives from the ICU 10 inbound packets that are forwarded to the ingress memory manager 44 for storing the packets in the data memory. The input controller 50 further receives packet request messages which are forwarded to the PBN buffer 42 for retrieving packets for the ECU 12. In alternate embodiments, the input controller 50 may receive additional messages from the ECU, such as, for example, booking messages associated with a packet stored in memory indicating that the packet is to be maintained in memory until requested by the ECU.

The output controller 52 transmits notification messages to the ECU indicating that a packet that the ECU may be interested in receiving has been received and stored in the data memory 40. The output controller 52 also receives packets retrieved from the data memory 40 and forwards those packets to the ECU 12 upon request by the ECU.

It is understood, of course, that FIG. 5 illustrates a block diagram of the PBU 14 without obfuscating inventive aspects of the present invention with additional elements and/or components which may be required or desirable for creating the PBU. For example, the PBU may include a separate notification logic and associated tables for transmitting notifications to the ECU. The PBU may also include a booking buffer reflecting booking messages received from the ECU. These additional components are described in further detail in the above-referenced U.S. Patent Application entitled “Distributed Shared Memory Packet Switch.”

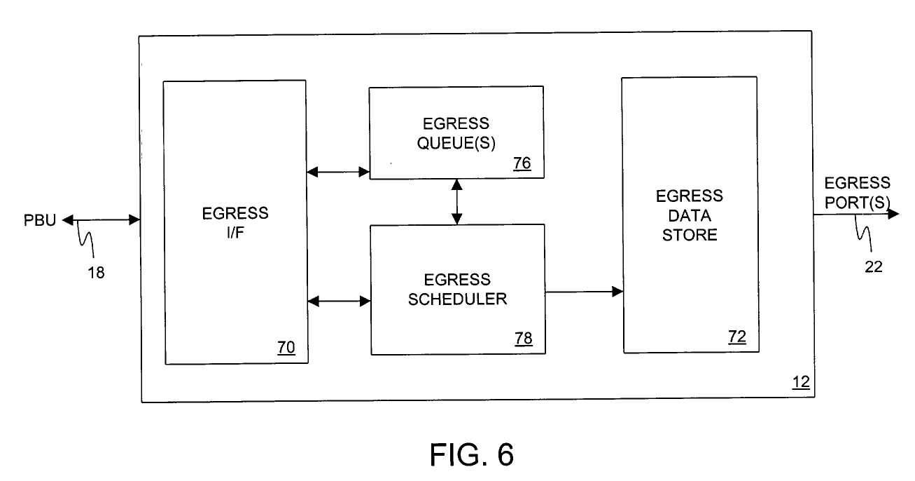

FIG. 6 is a schematic block diagram of an exemplary ECU 12 according to one embodiment of the invention. According to the illustrated embodiment, the ECU 12 includes an egress interface 70 receiving different types of packets from the PBU 12. The egress interface 70 processes and forwards those packets to the appropriate egress components.

According to one embodiment of the invention, the egress interface 70 transmits data packets retrieved from the PBU 12 to an egress data store 72 for temporarily storing the packet prior to forwarding over one or more egress ports 22. The egress data store 72 may be implemented as a first-in-first-out (FIFO) buffer. The egress data store 72 may be desirable if the data rate of one or more of the egress ports 22 is higher or lower than the data rate of the link 18 used to communicate with the PBU 12. An embodiment may exist, however, where the ECU 12 does not include an egress data store 72.

The egress interface 70 further receives notification messages from the PBU 12 indicating that a packet that the ECU may be interested in receiving has been stored in the data memory 40. If the queue level of one or more egress queues 76 associated with the packet are too high, the notification is discarded for those queues whose levels are identified as being too high. For the other associated queues, the egress interface 70 stores in the queues a PBN associated with the packet. According to one embodiment, the egress interface 70 may transmit a booking message to the PBU 14 indicating that the PBN was enqueued, and that the associated packet is to be maintained in the data memory 40.

The ECU 12 includes an egress scheduler 78 that dequeues the PBN numbers from each egress queue 76 according to a particular scheduling algorithm, such as, for example, a weighted round robin algorithm, class based dequeuing, or the like. When a packet associated with an enqueued PBN is scheduled to be forwarded as determined by the scheduling mechanism, the egress interface transmits a packet request message to the PBU 12. According to one embodiment, the packet request message includes the enqueued PBN, allowing the PBU to identify the appropriate packet to be retrieved. Once the packet is received, the ECU temporarily stores the packet in the egress data store 72.

Because the packets are retrieved in a backward manner by the PBU where the end of the packet is retrieved first and the end of the packet is retrieved last, the ECU also reads the packets in a backward manner in forwarding the packet via one or more appropriate egress ports, neutralizing the backward retrieval by the PBU. In this manner, the packet is forwarded by the ECU in a correct order, where the beginning of the packet is forwarded first and the end of the packet is forwarded last.

The access of the shared packet data memory 40 will now be described in more detail. According to one embodiment of the invention, the data memory 40 emulates a dual port memory by dividing the memory into the upper data memory 40a and the lower data memory 40b, each of which is implemented as a single port memory. The dual port emulation allows a write action invoked by the ingress memory manager 44 in storing data in the data memory 40, to occur, in a non-blocking way, in a same operation cycle as a read action invoked by the egress memory manager 48 in retrieving data from the data memory. If no read action is needed, double write actions may also be performed within a single operation cycle. The dual port emulation scheme, therefore, helps increase throughput via single port memories without the risk of read-write collisions.

According to one embodiment of the invention, read operations have precedence over write operations. According to this embodiment, the address of a next scheduled read operation determines the portion of the data memory that will be accessed for a scheduled write operation. If the read operation is scheduled to be performed in the upper data memory 40a, the write operation is performed in the lower data memory 40b, and vice-versa. At each cycle, therefore, the read and write operations may be performed simultaneously, in a non-blocking manner.

During the write operations, a data packet is stored in memory on a data-word-by-data-word basis in different memory locations where each memory location stores a current data word and a pointer to an adjacent data word. If the pointer is a next pointer to a next data word, a forward pointing mechanism of the data words may be generated. However, in emulating a dual port memory via single port memories where read operations have precedence over write operations, it is a current read operation that determines where a next read operation is to occur, and hence, where a next write operation is also to occur. Thus, the next pointer information is not generated by a current write operation, but by a next read operation. This implies that the storing of the pointer may not be handled during a current write action when the current portion of the packet data is stored. Instead, the pointer information is not completed until after a next read operation has determined what the next write pointer will be, implying an additional reading, modification, and writing step in order to retrieve and correctly set the next pointer information.

According to one embodiment of the invention, instead of utilizing a forward pointing mechanism where additional operational cycles are needed for obtaining and correcting the appropriate next write pointer information, a backward pointing mechanism is used where instead of storing a data word and a pointer to a next data word of the packet, a pointer to a previous data word is stored. Because the previous pointer information is available during the storing of a current data word, the data and pointer information may both be stored during a single, current write step. Thus, the reading and writing steps may be concurrently performed and completed during the single operational cycle.

In an alternative embodiment, a forward pointing mechanism may be implemented by maintaining an internal 1 bit counter that continuously toggles between 0 and 1. The counter may be used to associate the value 0 with the upper data memory and the value 1 with the lower data memory, and alternate the reads and writes so that at one point, read=upper memory, write=lower memory, and at a subsequent point read=upper memory, write=lower memory. Because the memory unit for which a next write action is to be performed is known in advance, the next write pointer may be pre-fetched for storing with the current data packet to allow the forward pointing mechanism.

In yet another embodiment, the forward pointing mechanism may be implemented by giving precedence to write operations over read operations. In this manner, the memory unit to be accessed for a next scheduled write action may be determined by a current write action, allowing the next write pointer to be pre-fetched from the identified memory unit. The memory unit to be accessed for the next scheduled read action is also determined by the current write action. However, the actual next scheduled read action may or may not occur based on whether the address of the next scheduled read coincides with the selected memory unit.

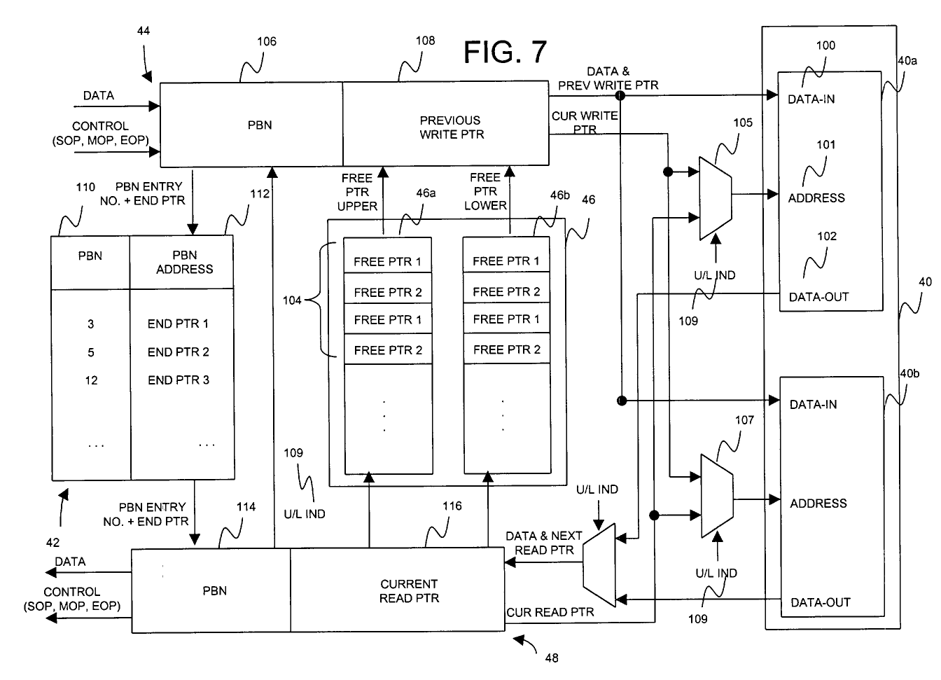

FIG. 7 is a more detailed block diagram of a portion of the PBU 14 of FIG. 5 according to one embodiment of the invention. The ingress memory manager 44 includes a PBN register 106 and a previous write pointer register 108. The PBN register 106 temporarily stores an address to the PBN buffer, referred to as the PBN, for storing a pointer to the packet once the packet is stored in the data memory 40. The PBN is selected, for example, from a free PBN buffer (not shown) when a start of packet (SOP) is detected by the ingress memory manager.

The previous write pointer register 106 stores a pointer to a memory location that was used to store a previous portion of the packet. The previous write pointer register 106 is updated as each portion of the packet being streamed is stored in available locations of the data memory 40. The pointer in the previous write pointer register 106 is stored in memory in conjunction with a current portion of the data packet.

The free pointer buffer 46 stores a list of free pointers 104 to available locations in the data memory 40 where the packets may be stored. The list of free pointers 104 is separated into the upper buffer portion 46a and the lower buffer portion 46b. The upper buffer portion stores pointers to available memory locations in the upper data memory 40a and the lower buffer portion stores pointers to available memory locations in the lower data memory.

According to one embodiment, for each portion of the packet to be stored, the free buffer transmits to the ingress memory manager 44 both a free upper pointer from the upper buffer portion 46a and a free lower pointer from the lower buffer portion 46b. The free upper pointer is transmitted to an upper memory address selector 105 and the free lower pointer is transmitted to a lower memory address selector 107. The actual pointer selected as the address of the memory to store the data is determined by an upper/lower (U/L) read indicator 109 which enables either the free upper pointer or the free lower pointer based on a next scheduled read action. Only one free pointer is consumed per transaction, and the unused pointer returned to the free pointer buffer. If the next scheduled read is on the lower data memory 40b, the U/L read indicator causes the selection of the free upper pointer as the address for writing a current portion of the packet. In this way, read and write actions may be performed concurrently in a non-blocking manner within the same operational cycle, emulating a dual port memory.

According to one embodiment, if no read action is scheduled, a weighted pseudo random algorithm is used to determine whether the free upper pointer or the free lower pointer is selected. The weight is allocated accordingly based on the number of free pointers in the upper buffer portion and the lower buffer portion. According to another embodiment, both free pointers are be used for performing two write actions concurrently in the event that no concurrent read action is scheduled.

The data memory 40 includes the upper data memory 40a and the lower data memory 40b. Each portion of the data memory is implemented as a single port memory having a single data-in port 100, a single address port 101, and a single data-out port 102. The data-in port 100 receives from the memory manager 44 a portion of the packet to be stored and a previous write pointer. The address port 101 receives an address in the data memory used for storing or retrieving data. The data-out port 102 transmits data retrieved from the memory.

Upon detection of an end of packet (EOP) by the ingress memory manager 44, the end portion of the packet is stored in a memory location indicated by a current free pointer retrieved from the free pointer buffer 46. The current free pointer is stored in the PBN buffer at the address indicated by the PBN in the PBN register 106. Notifications to interested ECUs are also sent by the output controller 52 with the PBN indicating that the stored packet may be retrieved using the PBN.

The PBN buffer 42 includes a plurality of PBN addresses 112 where each PBN address refers to a memory location storing all or a portion of a particular packet. According to one embodiment, each PBN address refers to a memory location storing an end portion of a packet. Each PBN address may be accessed via its associated PBN 110.

The egress write table 48 includes a PBN register 114 and a current read pointer register 116. The PBN register stores the PBN of a packet requested by the ECU 12. The PBN is used to retrieve an associated PBN address from the PBN buffer 42. The retrieved PBN address is stored in the current read pointer register 116. The PBN address is used as a start address of a linked list of pointers to memory locations in the data memory 40 storing the requested packet. The egress memory manager 48 further determines whether the PBN address refers to the upper data memory 40a or the lower data memory 40b, and sets the U/L read indicator 109 accordingly.

As a current portion of the packet is read, a next portion of the packet to be retrieved is determined by the previous pointer stored with the retrieved data. The egress write table 48 updates the current read pointer register 116 with the previous pointer, allowing data associated with the previous pointer to be retrieved.

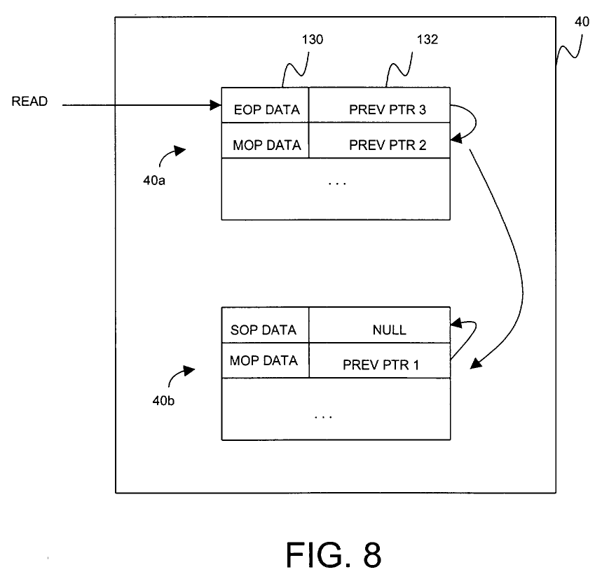

FIG. 8 is a schematic layout diagram of the data memory 40 divided into the upper data memory 40a and the lower data memory 40b according to one embodiment of the invention. Each portion of the data memory includes a plurality of entries, each entry including packet data 130 and an associated previous pointer 132. If an entry in the memory stores a start portion of a particular packet, the associated previous pointer is the NULL pointer. All other portions of the packet are stored in conjunction with a previous pointer that references a previous portion of the packet that is stored in the memory. In this manner, an entire packet may be referenced in a backwards manner, where an end of the packet is referenced first and the beginning of the packet is referenced last, via a linked list of previous pointers. Via such a backward pointing mechanism, a single write step may be used for determining and storing the pointer instead of the additional steps that may be required for later determining and filling-in the pointer information for a forwarding pointing mechanism.

In retrieving a packet via a read action, the data associated with the end of the packet is retrieved first, and its associated previous pointer is used to retrieve data associated with the middle of the packet. The previous pointer associated with the retrieved middle of the packet is further used to retrieve additional middle portions of the packet until a NULL pointer is reached, and data associated with the start of packet is finally retrieved.

The packet retrieved in such backwards manner is transmitted to the requesting ECU, which, in order to neutralize the backwards retrieval of the packet, also reads the packet in a backwards manner prior to transmitting via its egress port. The backwards reading by the ECU causes the packet to be transmitted in a correct order, transmitting the beginning of the packet first and the end of the packet last.

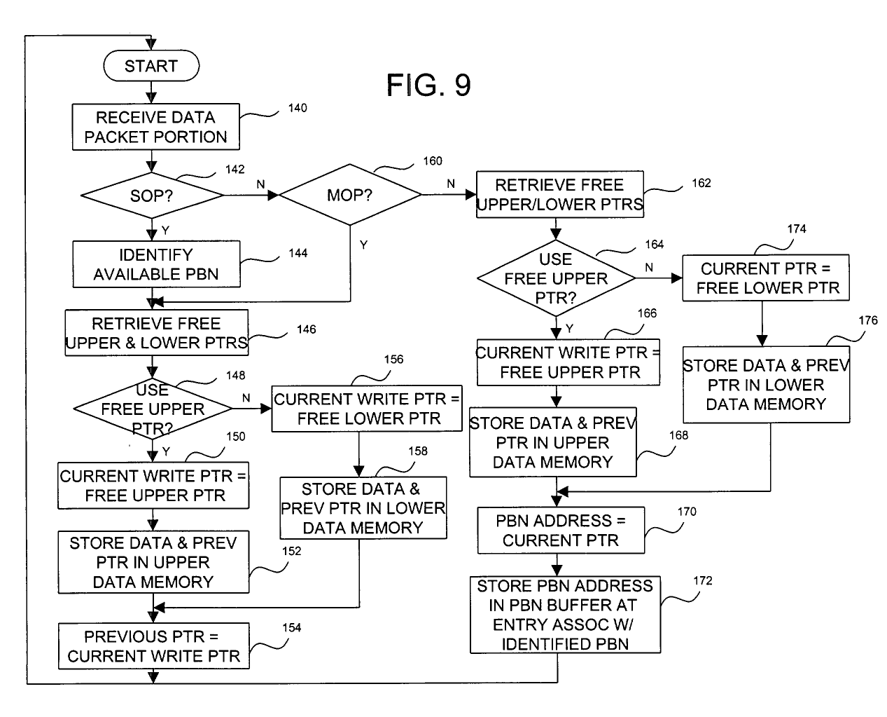

FIG. 9 is a flow diagram of a process exercised by the PBU 14 in storing packets according to a dual port memory emulation scheme. The process starts, and in step 140, the PBU 14 receives a portion of an inbound packet and transmits the portion to the ingress memory manager 44. The ingress memory manager 44 determines whether the portion of the packet received is a SOP, MOP, or EOP. In step 142, if the packet received is a SOP, the ingress memory manager 44, in step 144, identifies an available PBN. In addition, the ingress memory manager, in step 146, retrieves a free upper and lower pointer from the free pointer buffer 46. Based on a next scheduled read operation to be performed on the data memory 40, a determination is made as to whether the free upper pointer or the free lower pointer is to be used. If the free upper pointer is to be used, as determined in step 148, the current write pointer is set to the free upper pointer. In step 152, the packet data is stored in the upper data memory in the memory location indicated by the free upper pointer. The previous write pointer maintained by the ingress memory manager 44 is also stored at the memory location. For a start of packet, the previous pointer is set to NULL.

If the free lower pointer is to be used, the current write pointer is set to the free lower pointer in step 156. In step 158, the packet data and associated previous pointer is stored in the memory location indicated by the free lower pointer.

In step 154, the previous pointer register 108 of the ingress memory manager 44 is updated with the current write pointer.

In step 160, if a next portion of the packet to be stored is a MOP, steps 146-154 are again preformed where the free upper and lower pointers are retrieved, one of the free pointers is selected for use in storing the packet based on a next scheduled read operation, and the previous pointer is updated with the current write pointer.

In step 162, if a next portion of the packet to be stored is a EOP, free upper and lower pointers are retrieved from the free pointer buffer 46, and a determination is made as to whether the free upper pointer or the free lower pointer are to be used based on a next scheduler read operation. In step 164, if the free upper pointer is to be used, the current write pointer is set to the free upper pointer in step 166. In step 168, the end portion of the packet and the previous pointer are stored in the upper data memory in the memory location indicated by the free upper pointer.

Otherwise, if the free lower pointer is to be used, the current write pointer is set to the free lower pointer in step 174, and the end portion of the packet and the previous pointer are stored in the lower data memory in step 176.

In step 170, the current pointer becomes a PBN address, and in step 172, the PBN address is stored in the PBN buffer 42 at an entry addressed by the identified PBN.

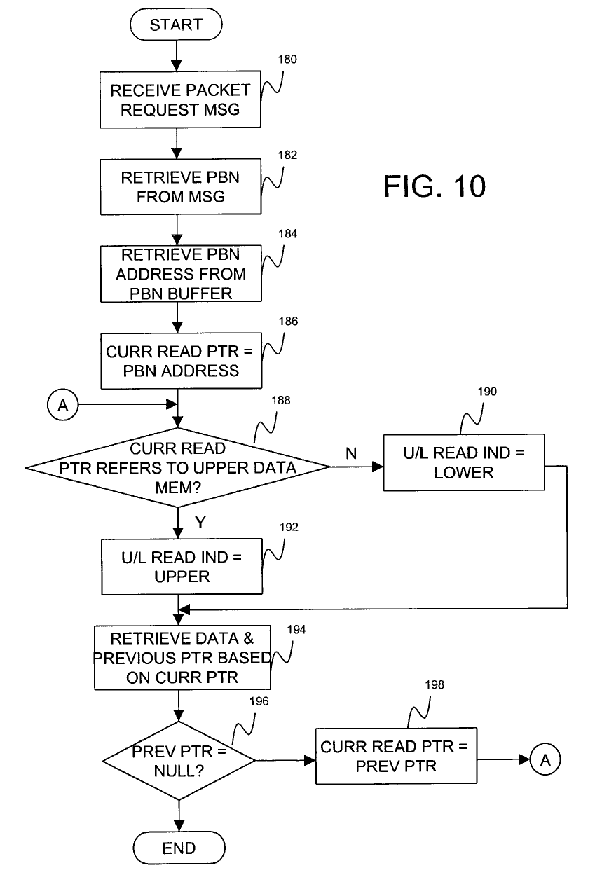

FIG. 10 is a flow diagram of a process exercised by the PBU 14 in retrieving packets according to a dual port memory emulation scheme. The process starts, and in step 180, the PBU receives a packet request message from the ECU. According to one embodiment, the packet request message includes the PBN of the desired packet. In step 182, the PBN is retrieved, and in step 184, the associated PBN address is retrieved from the PBN buffer 42. According to one embodiment, the PBN address is the address of a memory location storing an end portion of the desired packet.

In step 186, a current read pointer is set to the retrieved PBN address. In step 188, a determination is made as to whether the current read pointer refers to the upper data memory 40a or the lower data memory 40b. If the current read pointer refers to the upper data memory, the U/L read indicator is set to “upper” in step 192. Otherwise, the U/L read indicator is set to “lower” in step 190.

In step 194, the data and previous pointer stored at the current read pointer location is retrieved. The current read pointer is also returned to the free pointer buffer 46 if, for multicast transmissions, it is a last readout of the portion of the packet.

In step 196, a determination is made as to whether the retrieved previous pointer is a NULL pointer. If the answer is YES, the beginning of the packet has been retrieved, and the process ends. Otherwise, the current write pointer is set to the retrieved previous pointer for retrieving a previous portion of the packet from the link list of packets.

Although this invention has been described in certain specific embodiments, those skilled in the art will have no difficulty devising variations which in no way depart from the scope and spirit of the present invention. For example, the steps indicated in the flow diagrams of FIGS. 9 and 10 may be practiced in the order indicated, or in any other order that may be devised by a person skilled in the art. It is therefore to be understood that this invention may be practiced otherwise than is specifically described. Thus, the present embodiments of the invention should be considered in all respects as illustrative and not restrictive, the scope of the invention to be indicated by the appended claims and their equivalents rather than the foregoing description.

What is claimed is:

1. A switch fabric with a dual port memory emulation scheme, the switch fabric comprising:
an input; and
a memory coupled to the input including a first memory unit and a second memory unit, characterized in that either the first memory unit or the second memory unit is selected for performing a first memory access operation on at least a portion of a first packet, the selection being based on the memory unit selected for performing a second memory access operation on at least a portion of a second packet.

2. The switch fabric of claim 1, wherein the first memory access operation is a write operation.

3. The switch fabric of claim 1, wherein the second memory access operation is a read operation.

4. The switch fabric of claim 1, wherein if the first memory unit is selected for performing the second memory access operation, the second memory unit is selected for performing the first memory access operation, and if the second memory unit is selected for performing the second memory access operation, the first memory unit is selected for performing the first memory access operation.

5. The switch fabric of claim 1 wherein each memory unit is a single port memory unit including a single data-in port, a single address port, and a single data-out port.

6. The switch fabric of claim 1 further comprising a buffer storing a previous reference to a memory location accessed for a previous first memory access operation.

7. The switch fabric of claim 6 characterized in that the first memory access operation stores the previous reference retrieved from the buffer.

8. The switch fabric of claim 7, wherein the previous reference is a NULL pointer.

9. The switch fabric of claim 6, wherein the buffer is updated with a reference to a memory location in the first or second memory unit selected for performing the first memory access operation.

10. The switch fabric of claim 1, wherein the first packet includes a plurality of first data words and the second packet includes a plurality of second data words, the first data words being selected according to a first order for the first memory access operation and the second data words being selected according to a second order for the second memory access operation.

11. The switch fabric of claim 10, wherein the first order operates on a data word associated with a start of the first packet prior to operating on a data word associated with an end of the first packet, and the second order operates on a data word associated with an end of the second packet prior to operating on a data word associated with a start of the second packet.

12. A switch fabric with a dual port memory emulation scheme, the switch fabric comprising:
a first single port memory including a single first input port, a single first address port, and a single first output port; and
a second single port memory including a single second input port, a single second address port, and a single second output port, characterized in that if a second memory access operation is to be performed on the first single port memory, a first memory access operation is performed on the second single port memory, and if the second memory access operation is to be performed on the second single port memory, the first memory access operation is performed on the first single port memory.

13. The switch fabric of claim 12, wherein the first memory access operation is a write operation.

14. The switch fabric of claim 12, wherein the second memory access operation is a read operation.

15. The switch fabric of claim 12 wherein the first and second access operations are performed concurrently in a non-blocking manner.

16. A method for accessing a switch fabric having a memory with a first single port memory including a single first input port, a single first address port, and a single first output port, and a second single port memory including a single second input port, a single second address port, and a single second output port, the method comprising:
determining a memory address for a second memory access operation;
if the memory address is associated with the first single port memory, performing a first memory access operation on the second single port memory; and
if the memory address is associated with the second single port memory, performing the first memory access operation on the first single port memory.

17. The method of claim 16, wherein the first memory access operation is a write operation.

18. The method of claim 16, wherein the second memory access operation is a read operation.

19. The method of claim 16, wherein the first and second memory access operations are performed concurrently in a non-blocking manner.

20. The method of claim 16 further comprising maintaining in a buffer a previous reference to a memory location accessed during a previous first memory access operation.

21. The method of claim 20 further comprising retrieving the previous reference from the buffer and storing the previous reference retrieved from the buffer during the first memory access operation.

22. The method of claim 21, wherein the previous reference is a NULL pointer.

23. The method of claim 20 further comprising updating the buffer with a reference to a memory location in the first or second memory unit selected for performing the first memory access operation.

24. The method of claim 16, wherein the first memory access operation is performed on a first packet including a plurality of first data words and the second memory access operation is performed on a second packet including a plurality of second data words, the method further comprising selecting the first data words according to a first order for the first memory access operation and selecting the second data words according to a second order for the second memory access operation.

25. The method of claim 24, wherein the first order operates on a data word associated with a start of the first packet prior to operating on a data word associated with an end of the first packet, and the second order operates on a data word associated with an end of the second packet prior to operating on a data word associated with a start of the second packet.

26. A method for storing and retrieving packets from a switch fabric having a memory with a first memory unit and a second memory unit, the method comprising:
receiving an inbound packet;
retrieving a first reference to an available memory location in the first memory unit;
retrieving a second reference to an available memory location in the second memory unit;
selecting either the first reference or the second reference, the selection being based on the memory unit selected for performing a read action of a stored packet; and
writing at least a portion of the inbound packet in the memory location referred to by the selected reference.
